(19) United States
(12) Patent Application Publication
(10) Pub. No.: US 2016/0026269 A1
(43) Pub. Date: Jan. 28, 2016

(54) DEVICE FOR ENTERING INFORMATION INTO A DATA PROCESSING SYSTEM

(71) Applicant: ISIOIRI INTERFACE TECHNOLOGIES GnbH, Hagenberg (AT)

(72) Inventors: Robert KOEPPE, Linz (AT); Richard EBNER, Wels (AT)

(21) Appl. No.: 14/377,741

(22) PCT Filed: Jan. 21, 2013
(86) PCT No.: PCT/AT2013/050017

§ 371 Date: Aug. 8, 2014

(30) Foreign Application Priority Data
Feb. 10, 2012 (AT) A 173/2012

(51) Int. Cl. G06F 3/0354; G06F 3/042; G06F 3/038

(52) U.S. Cl. CPC G06F 3/03542; G06F 3/0386; G06F 3/0428

(57) ABSTRACT

A device for entering information into a data processing system having a position-sensitive optical sensor surface which is connected to the data processing system runs around a data processing system display surface, the optical sensor surface being suitable for detecting the position of the intersections between the sensor surface and a cross-sectional surface of a light beam emitted from a luminous indicator. A light curtain which is parallel to the display surface extends on the user side of the display surface, wherein the sensor surface is the optical detector of the light curtain.

The invention relates to a device for entering information into a data processing system.

AT 506 617 B1 and AT 507 267 A1 respectively describe a detector surface which generates electrical signals which depend on the coordinates of the point of incidence of a light beam and by means of which said coordinates become identifiable for a data processing system. The detector surface is substantially embodied as a film made of an organic material, from which electrical signals from spaced-apart tapping points can be read out, the relative magnitude of which signals with respect to one another depending on the distance of the tapping points from the point of incidence of the light beam triggering the signals. In accordance with the two documents, the detector surface can be applied to a display surface for a data processing system and the position of a processing marking within the display surface can be determined using a luminous pointer, typically a laser pointer, when incorporating the data processing system. In accordance with AT 506 617 B1, the detector surface is formed by a layer composite of a photoelectric layer with two-dimensional connection electrodes, of which at least one electrode has a significantly high electrical resistance, such that the electrical signal picked up by connection points at this electrode is noticeably reduced by the electrical resistance of the two-dimensional electrode. In accordance with AT 507 267 A1, the detector surface is formed by a luminescence waveguide and the spaced-apart tapping points are small-area photoelectric sensors. From the point of incidence of a light beam on the detector surface, light propagates in the luminescence waveguide by wave guidance and loses intensity with distance from the point of incidence, such that the signal measured at the photoelectric sensors is dependent on the distance of the sensors from the point of incidence. It is often considered to be disadvantageous in the processes in accordance with the two documents that the detector surface needs to be applied directly onto the display surface since, as a result of this, the quality of the display may suffer and costs and outlay scale proportionally with the area.

WO 2010/118450 A1 proposes the application of detector surfaces of the aforementioned type not directly onto the display surfaces but around these, the detector surfaces having the form of narrow, surrounding strips, with the plane of the strips lying parallel to the plane of the display surface. In this respect, it is furthermore proposed to make the position of a luminous beam incident on the display surface measurable by virtue of the cross-sectional area of the luminous beam being formed by a plurality of lines, which cross-sectional area extends over the display surface, at least to the framing by detector surfaces. The positions of the intersections of the cross-sectional area of the luminous beam, measurable therewith, are used to back-calculate the position of the cross-sectional center of the luminous beam on the display surface and this center can be assigned to a processing marking by a data processing system. Using this, the advantages of the above-described constructions are reached, without the display surface itself needing to be sensitive therefor. Costs and outlay of the detectors in this case only scale with the circumference of the display surface and the properties of the display surface itself are not adversely affected.

In addition to all the above-described detection principles, WO 2010/121279 A2 proposes to let the light intensity of the light beam emitted by the pointing device vary in pulse sequences, with certain pulse sequences, i.e. typically the succession in time of switched-on and switched-off states, being assigned a character code. This renders it possible to enter characters, such as e.g. letters or “enter”, via the detector surface into the data processing system connected to the detector surface by means of the pointing device. This also renders it possible to clearly distinguish a plurality of pointing devices for the data processing system by virtue of different pointing devices “transmitting” pulse patterns associated with different identification information.

In WO 2010/118449 A2, it is proposed to use the detection principle described in the documents AT 506 617 B1 and AT 507 267 A1, mentioned at the outset, for a two-dimensional detector for the application on light curtains.

The object of the invention is to improve the principle, known from WO 2010/118450 A1 and WO 2010/121279 A2, for entering data into a data processing system by means of optical detector surfaces, which are arranged on the edge of the display surface and are able to detect the position of the intersections of the area thereof with the cross-sectional area of a light beam emitted by a luminous pointer, in such a way that the display surface also becomes usable in the style of a touch-sensitive input area, i.e. that it can also detect the coordinates of the contact point of e.g. a finger or a stylus on the display surface.

To achieve the above and other objects the invention is directed to an arrangement of a light curtain in front of the display surface and parallel to the latter, and the guidance of the light from this light curtain onto those detector surfaces which surround the display surface.

Within the meaning of this document, a light curtain is an optical monitoring apparatus in which the principle of the photoelectric barrier is extended from a line-shaped monitoring region to a two-dimensional monitoring region. By virtue of such a light curtain being arranged in front of the display surface and parallel to the latter, any object touching the display surface must interrupt the light curtain and is therefore detected.

The invention is illustrated on the basis of schematic diagrams:

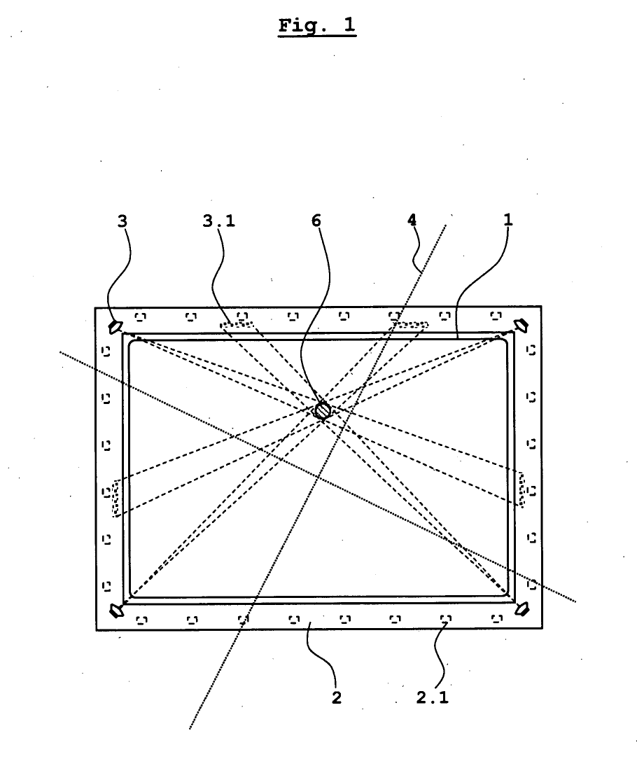

FIG. 1: shows a front view of a display surface equipped according to the invention,

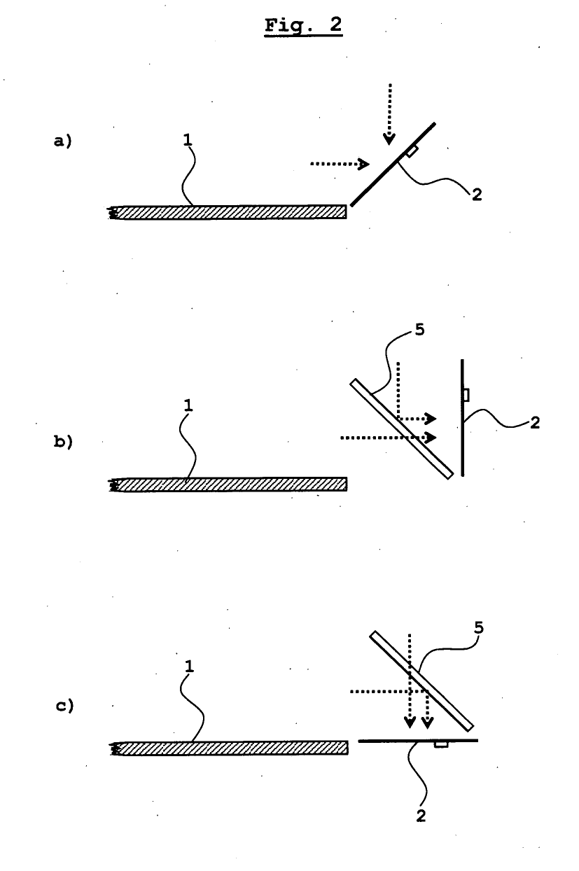

FIG. 2: shows a lateral sectional view of three embodiment versions of the edge region of display surfaces according to the invention, with the viewing direction lying parallel to the longitudinal extent of the relevant edge, and

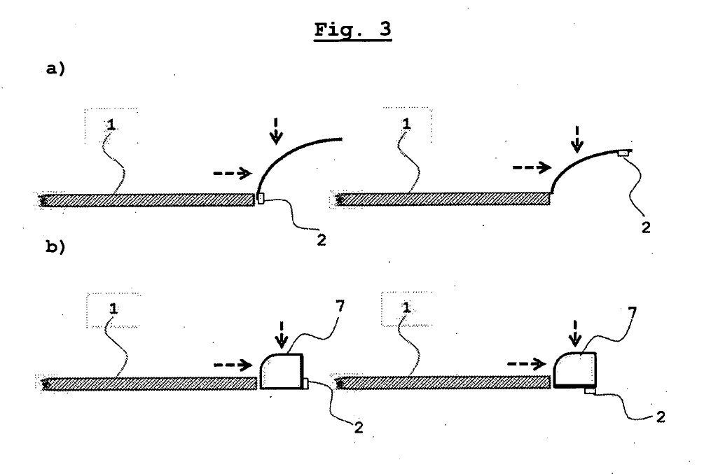

FIG. 3: shows four further embodiment versions, wherein, in the case a), use is made of a bent detector surface and, in the case b), the detector surface is attached to a body made of transparent material.

In accordance with FIG. 1, the rectangular display surface 1, which is typically a monitor area on which images are generated by a data processing system, is surrounded on all four sides by an optical, position-sensitive detector surface 2. The detector surface 2 has spaced-apart tapping points 2.1, at which electrical signals, the strength of which are dependent on the incidence of light signals on the detector surface, are generated and forwarded to the data processing system.

Four light sources 3 are arranged outside of the display surface on each corner and radiate over the display surface, in each case with a light beam aligned parallel to the display surface, said light beam having a line-shaped cross-sectional area which is also aligned parallel to the display surface. The light emitted by the light sources 3 is incident on the parts of the detector surface 2 in each case situated on the other side of the display surface. If an object 6, such as e.g. a stylus or a finger, approaches the display surface 1, this object 6 shadows part of the light emitted by the light sources 3, preventing it from reaching the detector surface 2. A shadowed region 3.1 for each light source 3 emerges on the detector surface 2. From knowing the position and extent of the shadowed regions, and the positions of the light sources 3, it is possible to calculate the position and contour of the object 6 on the display surface 1 as an intersection area of the connection areas between shadowed regions 3.1 and the respectively associated light sources 3. The center of the object 6 on the display surface can more easily be calculated as the point of intersection of at least two lines which in each case are the angle bisectors of a shadowed region 3.1, emanating from the respectively associated light source 3.

In FIG. 1, the cross-shaped cross-sectional area 4 which is transmitted in the direction of the display surface by a luminous pointer (not depicted here)—such as, typically, a laser pointer with line optics—is indicated in the plane of the display surface using dotted lines. The cross-shaped cross-sectional area 4 of this light beam is incident on the detector surface 2 at a plurality of points.

Part of the cross-sectional area 4 of the light beam from the luminous pointer and the light beams emitted by the light sources 3 are therefore both incident on the detector surface 2. The light beam from the luminous pointer can be incident on the display surface and the detector surface from a large angular range around the normal of the display surface. The areas flooded with light by the light sources 3 are completely parallel, or approximately completely parallel, to the display surface.

FIG. 2 shows how it is possible to ensure that light coming from the light sources 3 and the light beam from the luminous pointer are both incident on the detector surface. The direction of incidence of the light beams is symbolized by arrows plotted in a dotted manner.

In the version in accordance with sketch a) of FIG. 2, the detector surface 2 is tilted with respect to the display surface 1 at an acute angle toward the side of the luminous pointer, wherein the normal distance from the plane of the display surface increases on the detector surface with increasing distance from the display surface 1. In this design, both the light which comes from the luminous pointer and the light which comes from the light sources 3 and propagates parallel to the display surface impinge on the detector surface 2 without requiring an additional semitransparent mirror 5 as in the version in accordance with sketches b) and c).

In versions b) and c) in accordance with FIG. 2, the detector surface 2 is aligned normal to the display surface 1, or parallel and flush with the display surface 1. So that light coming from the luminous pointer and light coming from the light sources 3 can both be incident on the detector surface 2, a semitransparent mirror 5 is arranged between one of the two light sources and the detector surface 2 at an acute angle with respect to the detector surface and with respect to the display surface. In place of a relatively wide semitransparent mirror 5a slender ordinary mirror can be used, in this case the light beam, which is shown in b) and c) and which passes through the semitransparent mirror in a straight line, has to pass by the ordinary mirror in order to be incident on the detector surface 2.

The detector surface 2 detects not only the incidence of light signals, but also the coordinates of the points of incidence thereof on the detector surface. Here, naturally, it is possible to detect not only points of incidence of “positive light signals”, i.e. the coordinates of locally delimited points at which higher light intensity prevails than in the surroundings, but also, conversely, the coordinates of “negative light signals”, i.e. the coordinates of locally delimited points at which lower light intensity prevails than in the surroundings. Hence, the detector surface 2 can detect both the coordinates of the intersection area thereof with the cross-shaped cross-sectional area 4 of the light beam from the luminous pointer and the coordinates of the regions 3.1 thereof which are shadowed from the light from the light sources 3 by the object 6.

Further advantageous arrangements and embodiments of the detector surface are shown in FIG. 3. Hence, the detector surface 2 can have a curved embodiment, as sketched in FIG. 3a), so that both the light beam 4 and the light beams 3 are incident in each case on parts of the detector surface at an acute angle. This design can bring about significant saving of space in comparison with the designs sketched in FIG. 2. In FIG. 3b), the detector surface is stretched over a voluminous body 7, which is made of a transparent plastic or glass and which guides both the light from the light beams 3 and the light from the light beam 4 to the detector surface by means of total internal reflection. Luminescent particles can be added to the body 7 in order to bring about improved transmission of the incident light from the light beams 3 and 4 to the detector surface.

It is possible to embody the detector surface 2 as a pixel field containing many small-area photo sensors, of which each individual one communicates as to whether or not it is hit by a light pulse, and wherein the spatial resolution exactly equals the pixel grid dimensions. However, this embodiment is either very expensive or has a very poor spatial resolution.

It is much better, in accordance with the principle set forth at the outset, to embody the detector surface 2 as a film made of an organic material, from which electrical signals from spaced-apart tapping points can be read out, the relative magnitude of which signals with respect to one another depending on the distance of the tapping points from the point of incidence of the light beam triggering the signals, such that the data processing system can be used to back-calculate the point of incidence on the detector surface from the magnitude of these signals.

In accordance with a first embodiment in this respect the detector surface 2 can be formed by a layer composite of a photoelectric area with two-dimensional connection electrodes, wherein at least one connection electrode has a high electrical resistance. The strength of the electrical signal picked up at tapping points 2.1 is depending on the distance of the tapping points 2.1 from the point at which a signal is generated, since the strength of the signal is reduced due to the high electrical resistance of the two-dimensional connection electrode as a function of distance.

In accordance with a second embodiment in this respect, which is particularly advantageous, the detector surface 2 is formed by a luminescence waveguide and the spaced-apart tapping points 2.1 are small-area photoelectric sensors. From the point of incidence of a light beam on the detector surface 2, light propagates in the luminescence waveguide by wave guidance and loses intensity with distance from the point of incidence, such that the signal measured at the photoelectric sensors 2.1 is dependent on the distance of the sensors 2.1 from the point of incidence.

In both embodiments, it is possible to have much fewer tapping points 2.1 than locations which can be distinguished as points of incidence of light signals. Moreover, in the required large-area embodiment, the designs are much cheaper than the aforementioned pixel embodiment. A further advantage over the pixel design lies in the robustness, pliability and mechanical flexibility of the detector surface.

The embodiment variant with the luminescence waveguide is particularly advantageous because it also allows a very high time resolution, that is to say that it is even possible to measure individual, extremely short light signals correctly and that this renders it possible to let the intensity of light signals vary with high modulation frequencies and also to recognize this modulation frequency in the signals from the detector surface. Hence, it is possible to encode light signals in an improved manner compared to other detection principles and to distinguish these from interfering surrounding light signals.

In an advantageous embodiment, the light coming from the light sources 3 is encoded, typically by specific variations in the light intensity, such that the data processing system can identify from which light sources 3 a signal originates (or is missing in the case of shadowing 3.1) on the basis of the measured signals. By way of example, the light sources 3 can be switched on and off at a specific (high) modulation frequency. However, by way of example, it is also possible that the individual light sources 3 are, in sequence, always only switched on individually in each case for a short period of time and then switched off again, such that only a single light source shines at any one time. From the knowledge of which light source 3 is on at which time, the data processing system can assign signals formed by shadowing 3.1 to specific light sources 3. Using logic analysis, the data processing system can thereby also distinguish and localize a plurality of shadowing objects 6 quite well, which are situated simultaneously on the display surface.

It is also advantageous (as is known per se from the above-mentioned WO 2010/121279 A2) to encode the light emitted from the luminous pointer to the display surface 1 and hence also to the detector surface 2. This encoding step should in any case contain identification information for the luminous pointer, for example in the form of a modulation frequency only assigned to this luminous pointer. As a result of this identification information, the luminous pointer can be distinguished from the light sources 3 and it is possible to use a plurality of luminous pointers simultaneously and the data processing system is able to distinguish which measurement signal originates from which luminous pointer, if required. In an advantageous embodiment the light signal emitted by a luminous pointer is altered in defined pulse sequences (which cannot be identified by the human eye due to the speed thereof), wherein certain pulse sequences are assigned to a character encoding, such that letters and other characters can be communicated to the data processing system by the luminous pointer via the detector surface 2. Furthermore, it is advantageous to use different coding for the various lines of the cross-sectional area 4 of the light beam emitted by the luminous pointer. As a result, the data processing system can exactly identify the rotational position of the luminous pointer and a meaning can be assigned to this information. As a result, it is possible, in particular, to control the rotation of an image element on the display surface by rotating the pointing device.

A further advantageous embodiment is the determination of the overall intensity of the electrical signal caused in the detector surface by the luminous pointer. If the luminous pointer is moved toward the display surface, or away therefrom, the resulting electrical signal changes due to the relatively large dilation of the light beam, and so information can be obtained about the distance and changes in the distance of the luminous pointer from the display surface. This information can in turn be considered as an input for the data processing system and a meaning can be assigned to a defined change. In particular, it is therefore possible to prompt a change in size of one or more image elements on the display surface by changing the distance between display surface and luminous pointer.

Therefore the input device according to the invention is able simultaneously to satisfy a number previously unachieved functions without being expensive and/or complicated.

In an advantageous development of the invention the shadowing object 6, which can be moved to the display area 1 by a person using the input device, contains a light source which emits light which can be detected by the detector surface 2. Preferable the object 6 can be identified by coding the light source (as described above on the basis of the light sources 3 and the luminous pointer) therefor any object 6 can be uniquely recognized amongst a plurality of such objects 6. By way of example, it is possible to draw or write on the display area using a shadowing object 6 when the path of motion of object 6 measured by the data processing system is displayed in color on the display area. As a result of the unique identifiability of a plurality of different shadowing objects 6 the path of motion of each individual object 6 can be displayed with an assigned individual color.

In a further advantageous development, shadowing objects 6, as described above on the basis of the luminous pointer, can send selectable characters or state information by encoded variation in the light intensity to the data processing system. In addition to the example mentioned above, this for example renders it possible to make the writing color assigned to a shadowing object 6 by the data processing system switchable.

It is advantageous to equip a shadowing object 6 containing a light source with a contact switch, such that it is possible to set that the object 6 only emits light if it rests against the display surface.

Due to the invention, it is possible to upgrade simple display surfaces which are only used to display information of data processing systems so that these display surfaces may also be used as graphical input devices for a data processing system, wherein these may offer an impressively high number of useful functions but nevertheless be cost-effective, convenient and robust.

Within the scope of the inventive concept, it is possible to let the light sources 3 in each case emit a single, line-shaped light beam (instead of a “two-dimensional” light beam) and to pivot the direction in which the light beam is emitted in a plane lying close to the display surface and parallel to the display surface.

By way of example, the pivoting can be brought about with the aid of a rotary mirror or with the aid of a mirror which is moved cyclically. The control of the pivot movement should be linked to the data processing system, such that the data processing system at all times “knows” the direction in which the light beam currently shines. Using the time information of the signals from the detector surface 2, the data processing system is able to identify the angle sectors of the region illuminated by a light source 3 in which a shadowing object 6 is situated.

Instead of affixing the light sources 3 directly on the side of the plane of the display surface 1 facing the user, it is also possible to affix these behind this plane or at a completely different location and guide the light to the side of the display surface 1 facing the user by means of optical waveguides and/or mirrors.

It is likewise also possible to arrange the detector surface 2 on the side of the display surface 1 facing away from the user and guide the light from the light sources 3 through the plane of the display surface by means of mirrors.

The two last-mentioned options may be advantageous, especially in the case of exposed display surfaces, particularly in respect of protecting sensitive parts from damage by contamination and inappropriate contact.

In a particularly advantageous embodiment predominantly for the application in computer games, the luminous pointer, i.e. the pointing device which is situated in the hand of a user and emits a light beam to the display surface 1 and the detector surface 2, is equipped with inertial sensors, i.e. linear and/or rotational accelerometers, the measurement results of which are transmitted to the data processing system. Hence, information about the movements of the pointing device can also be communicated to the data processing system when the light beam emitted by the pointing device is not impinging on the detector surface 2. Whenever the luminous pointer is impinging on the detector surface 2, it is possible to calculate absolute position data (and not only the data relating to change in position).

1. A device for entering information into a data processing system, comprising:
a display surface,
a data processing system,
an optical pointer configured to transmit a light beam that has a cross-sectional shape that projects onto the display surface and outside a surface area of the display surface,
a light curtain which is configured to be arranged parallel to the display surface and extends on the user side thereof,
a position-sensitive optical detector surface that is connected to the data processing system,
said detector is configured to be arranged about edges of the display surface, said detector surface is configured to be able to detect the position of the intersections between the area of said detector surface and a cross-sectional area of the light beam emitted by said luminous pointer, and said detector surface is configured to be also the optical detector of said light curtain.

2. The device as claimed in claim 1, wherein the cross-sectional area of the light beam of the luminous pointer is formed by a plurality of lines and the dimensions of this cross-sectional area extends beyond the display surface and the detector surface.

3. The device as claimed in claim 1, wherein the detector surface is a film made of an organic material which comprises spaced-apart tapping points from which electrical signals can be read out, the relative magnitude of which signals with respect to one another depending on how far away the individual tapping points are from the point of incidence of a light signal that is generating the signals in the detector surface.

4. The device as claimed in claim 3, wherein the detector surface is formed by a layer composite of a photoelectric layer with two-dimensional connection electrodes, wherein at least one connection electrode has a high electrical resistance, such that the electrical signal picked up at tapping points at this electrode is noticeably reduced by the electric resistance in the two-dimensional connection electrode, depending on the distance of the tapping points from the point at which a signal is generated.

5. The device as claimed in claim 3, wherein the detector surface is formed by a luminescence waveguide and the spaced-apart tapping points are small-area photoelectric sensors.

6. The device as claimed in claim 1 wherein the light for the light curtain originates from a plurality of light sources which, from different sides, shine over the display surface on the side facing the user.

7. The device as claimed in claim 6, wherein the light emitted by different light sources is individually encoded for the respective light source, preferably by a frequency of the variation, individual to the respective light source, in the intensity of the emitted light.

8. The device as claimed in claim 1 wherein the light emitted from the luminous pointer to the display surface and hence also to the detector surface is encoded, preferably by characteristic pulse sequences.

9. The device as claimed in claim 1 wherein it comprises a object which can be moved to the display surface by the user, wherein the object partly shadows light from the light sources from the detector surface and wherein the object itself emits light which can be detected by the detector surface.

10. The device as claimed in claim 9, wherein the device comprises a plurality of objects, wherein different objects emit differently encoded light signals.

11. The device as claimed in claim 6 wherein the light sources in each case emit a single, line-shaped light beam and the direction in which the light beam is emitted pivots in a plane lying close to the display surface and parallel to the display surface.

12. The device as claimed in claim 1 wherein the luminous pointer, i.e. the pointing device which is situated in the hand of a user and emits a light beam to the display surface and hence also to the detector surfaces, is equipped with inertial sensors, i.e. linear and/or rotational accelerometers, the measurement results of which are transmitted to the data processing system.
